(19) United States
(12) Patent Application Publication
(10) Pub. No.: US 2008/0224614 A1
(43) Pub. Date: Sep. 18, 2008

(54) Looped Frame Arc Tube Mounting Assembly for Metal Halide Lamp

(75) Inventors: Joseph Woods, Hammondsport, NY (US); John Bailey, Bradford, NY (US); Joseph Carbone, Hornell, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,173

(22) PCT Filed: Nov. 13, 2006
(86) PCT No.: PCT/IB06/54225

§ 371 Date: Apr. 23, 2008

Related U.S. Application Data
(60) Provisional application No. 60/736,273, filed on Nov. 14, 2005.

(51) Int. Cl. H01J 17/18

(52) U.S. Cl. 313/625

(57) ABSTRACT

An arc tube mounting assembly (1) for a metal halide arc lamp (10) includes frame members (8, 9) for supporting an arc tube (2). The arc tube (2) is supported from above by a looped frame member (8) having a loop (8A) which extends along opposing sides, and across top and base ends (2A, 2B) of the arc tube (2), thus evenly distributing the current to discharge electrode 7, thereby cancelling magnetic forces which could displace the arc from the center of the arc tube (2), resulting in improved lumen maintenance and extended life. A centering circle (8B) of the frame member (8) wraps around the lower ceramic end plug (4), providing coaxial alignment of the arc tube (2) and the tubular outer envelope (11).

This invention relates to metal halide arc lamps, and more particularly relates to an improved arc tube mounting assembly for a compact metal halide lamp, and also relates to a lamp incorporating such an improved assembly.

Metal halide arc lamps are known to be susceptible to arc bending, caused by asymmetric magnetic forces set up by current-carrying support members. Such arc bending moves the arc closer to a sidewall of the arc discharge vessel, raising the temperature of the wall, and leading to shorter lamp life or even to catastrophic failure of the discharge vessel.

United States Patent Application Publication 2003/0062831 provides special frame wire structures for stabilizing the arc of a ceramic high intensity discharge (HID) lamp. In one embodiment, two identical frame wires run parallel to one another along opposite sides of and equidistant from the arc tube. The current load to the discharge electrode distal from the base of the lamp is shared by these frame wires. This arrangement is said to greatly reduce or eliminate detrimental interaction between the frame wires and the arc.

The frame wire structures described in United States Patent Application Publication 2003/0062831 were developed for ceramic metal halide discharge lamps of the Philips MasterColor® series having a power range of about 150 W to about 1000 W, and a color temperature of about 3800 K to about 4500 K. However, in the case of compact metal halide discharge lamps having a power range of about 20 W to 400 W, and a color temperature of about 3000 K to 4000 K, a simpler, more compact arrangement is desired.

According to the invention, an arc tube mounting assembly for a metal halide lamp is provided, in which the arc tube is suspended from the top of a looped frame member having a loop which encompasses the arc tube in an axial plane of the arc tube. The arc tube is suspended from the loop via the discharge electrode which extends from the top end of the arc tube (distal electrode). The distal electrode is electrically connected to the top of the loop, and current is provided to the base end of the loop, whereby current delivered to the discharge electrode is distributed entirely around the arc tube, thereby cancelling magnetic forces which could displace the arc from the center of the arc tube, resulting in improved lumen maintenance and extended life.

According to one aspect of the invention, an arc tube mounting assembly for a metal halide lamp comprises:

a discharge vessel enclosing a discharge space containing a fill capable of sustaining an arc discharge;

a pair of end plugs extending from opposing base and top ends of the discharge vessel;

a pair of discharge electrodes arranged at opposing ends of the discharge space, and extending out of the discharge vessel through the end plugs, respectively, in a gas-tight manner;

a looped frame member consisting of a loop and a centering circle;

the loop extending along one side of the arc discharge vessel from a base end, then across the electrode distal from the base end, making electrical contact with the distal electrode at a point, then along an opposite side of the arc discharge vessel, and finally crossing the proximal end plug to a terminal end, which makes electrical connection at a point 8F above the base end loops around the proximal electrode;

the centering circle looping around the proximal end plug.

The loop distributes the current to the distal electrode on opposite sides of, as well as above and below the arc tube, so as to minimize the generation of magnetic fields which could bend the arc, leading to elevated wall temperatures and deterioration of the arc tube. The loop also supports and aligns the distal end of arc tube, via connection with the distal electrode, while the centering circle aligns the proximal end of arc tube.

A second, shorter frame member, supports the proximal end of arc tube, by making electrical connection to the proximal electrode.

In a preferred embodiment, the assembly is for insertion into a tubular outer envelope, the loop exhibits resiliency, e.g., by virtue of the looped frame member having been formed from a spring material, and the loop has a width dimension slightly wider than the inner diameter of the outer tubular envelope, so that upon insertion of the mounting assembly into the envelope, the loop bears against the inner wall of envelope, thereby providing further alignment and support of the arc tube within the envelope.

According to another aspect of the invention, a metal halide lamp comprises:

an outer envelope having a top end and a base end;

a lamp base; and

and an arc tube mounting assembly comprising;

an arc tube enclosing a discharge space containing a fill capable of sustaining an arc discharge;

a pair of end plugs extending from opposing base and top ends of the discharge vessel;

a pair of discharge electrodes arranged at opposing ends of the discharge space, and extending out of the discharge vessel through the end plugs, respectively, in a gas-tight manner;

a looped frame member consisting of a loop and a centering circle;

the loop extending along one side of the arc discharge vessel from a base end, then across the electrode distal from the base end, making electrical contact with the distal electrode at a point, then along an opposite side of the arc discharge vessel, and finally crossing the proximal end plug to a terminal end, which makes electrical connection at a point 8F above the base end loops around the proximal electrode;

the centering circle looping around the proximal end plug; and

a lower frame member electrically connected to the proximal discharge electrode.

The looped frame member evenly distributes the current to the distal discharge electrode, thereby cancelling magnetic forces which could displace the arc from the center of the arc tube, resulting in improved lumen maintenance and extended life.

The centering circle of the looped frame member wraps around the proximal end plug, providing coaxial alignment of the arc tube with the outer envelope of the lamp. The centering circle, by virtue of its proximity to the proximal discharge electrode of opposite polarity, also acts as an auxiliary electrode which aids in lamp starting.

The invention is usefully embodied in compact tubular “T” metal halide lamps of medium wattage (>20 W to 400 W) with a color temperature target of 3000K to 5600 K, an outer tubular envelope of fused quartz and both the mount and foil materials of molybdenum. Such lamps with the looped frame assembly of this invention exhibit improved lumen maintenance and extended life over designs having an uneven current distribution.

These and other aspects of the invention will be further elucidated with reference to the Figures, in which:

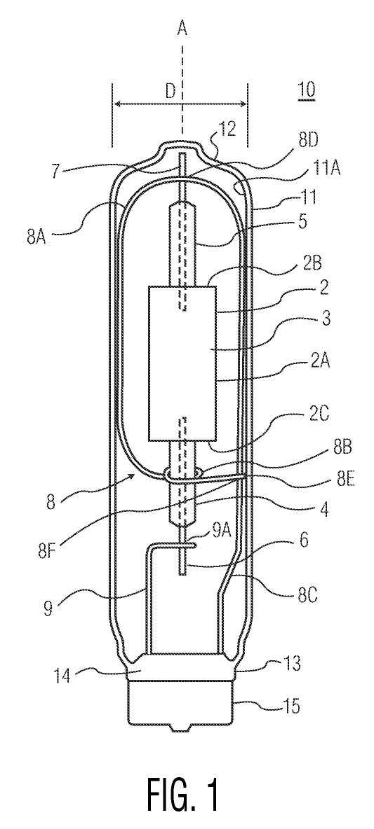

FIG. 1 is a front elevation view, partly cut away, of one embodiment of a ceramic metal halide lamp of the invention;

FIG. 2 is a schematic illustration of one embodiment of the looped frame portion of the arc tube mounting assembly of the invention; and

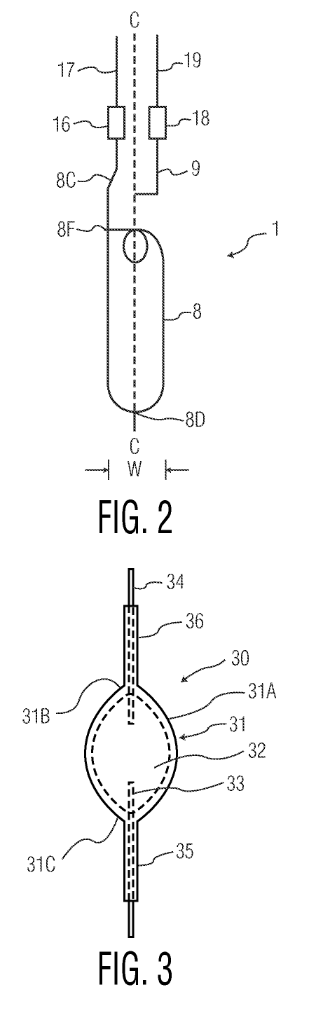

FIG. 3 is a front elevation view of another embodiment of the arc tube.

The Figures are diagrammatic and not drawn to scale. The same reference numbers in different Figures refer to like parts.

Referring now to FIG. 1, there is shown a front elevation view, partly cut away, of one embodiment of a ceramic metal halide lamp 10 of the invention, having a tubular outer envelope 11, typically of fused quartz, with sealed top and base ends 12 and 13, and a press seal 14. A ceramic base 15 is attached to the base end 13 of envelope 11.

Inside the envelope 11 is an arc tube mounting assembly 1, including a sealed ceramic arc tube 2, typically of polycrystalline alumina (PCA), which encloses a discharge space 3 having a fill, typically of mercury and a rare gas such as argon, which is capable of sustaining an arc discharge. Extending from base and top ends 2B and 2C of the arc tube 2, are ceramic end plugs 4 and 5, also typically of PCA. A pair of discharge electrodes 6 and 7 extend through the end plugs 4 and 5 into opposing ends of the discharge space 3, and are sealed in a gas-tight manner by end plugs 4 and 5.

The arc tube is supported inside the outer envelope 11 by a looped frame member 8. Frame member 8 has a large loop 8A, which extends entirely around the arc tube 2, and a small centering circle 8B, which winds around plug 4, and contributes to the axial alignment of the arc tube 2 and the tubular outer envelope 11.

The loop 8A extends along one side of the arc tube 2 from a base end 8C, then across the electrode 7 distal from the base end 2B of the arc tube 2, making electrical contact with the distal electrode 7 at a point 8D, then along an opposing side of the arc discharge vessel 2, and finally crossing the end plug 4 proximal to the base end 2B, to a terminal end 8E, which makes electrical connection at a point 8F above the base end 8C.

Electrical connection at points 8D and 8F is provided, e.g., by spot welding. The connection point 8D is chosen to coincide with the centerline C of the mounting assembly 1, so as to achieve coaxial alignment of the arc tube 2 with the outer tubular envelope 11.

A second, shorter frame member 9, supports the proximal end 2B of arc tube 2, by making electrical connection to the proximal electrode 6 at a point 9A.

A schematic illustration of the current paths provided by the mounting assembly is shown in FIG. 2. Frame member 8 forms a closed loop between point 8D, where it is electrically connected to discharge electrode 7, and point 8F, thus distributing current to the discharge electrode 7 approximately equally on opposite sides as well as the top and base ends of the arc tube 2, thereby minimizing or avoiding entirely magnetic fields which could cause the arc in discharge space 3 to bend outwardly toward the sidewall 2A of arc tube 2.

The base end 8C of frame member 8 is connected to a lead-through 17 via metal foil member 16. Frame member 9, which is electrically connected to discharge electrode 6 at point 9A, is connected at its other end to a lead-through 19 via metal foil member 18. Lead-throughs 17 and 19 provide current to the assembly via connections to the base 15, in the conventional manner. The press seal 14 of the outer envelope surrounds and embeds the metal foil members and adjacent portions of the frame members 8 and 9, and the lead-throughs 17 and 19, providing not only a gas-tight seal but also mechanical support for the frame members 8 and 9, and thus for the entire arc tube mounting assembly 1.

The loop 8A is preferably dimensioned to have a width W slightly greater than the inner diameter D of the outer envelope 11, and exhibits some resiliency, e.g., by virtue of having been formed from a spring material, so that upon insertion of the mounting assembly 1 into the envelope 11, the loop 8A bears against the inner wall 11A of envelope 11, thereby providing further support of the arc tube 2 within the envelope 11.

The centering circle 8B, by virtue of its proximity to the proximal discharge electrode 6 of opposite polarity, also acts as an auxiliary electrode which aids in lamp starting. The proximity of the two electrical conductors creates a large electric field. Also sharp surface features on the cermet surface of the discharge electrode enhances the electric field to cause breakdown in nearby gases which can supply ultraviolet radiation and free electrons to assist in the initial breakdown inside the unlit arc-tube. The creation of large electric fields between sharp surface features and external antenna wires to aid in lamp starting is known, for example, from U.S. Pat. Nos. 6,563,267 and 6,586,891.

FIG. 3 shows another embodiment of the arc tube 30, including a shaped central portion 31, in this case ovoid in shape, having a sidewall 31A, a top end 31B and a base end 31C, enclosing a discharge space 32, and having discharge electrodes 33 and 34 arranged at opposite ends of the discharge space 32 and extending into end plugs 35 and 36. Such an arc tube is fabricated from polycrystalline alumina (PCA), but could also be of fused quartz.

The invention is usefully embodied in compact tubular “T” metal halide lamps of medium wattage (>20 W to 400 W) with a color temperature target generally within the range of 3000 K to 4000 K, but extending as high as 5600 K.

The outer diameters of the T bulbs generally increase with increasing lamp wattage. Typical outer diameters are 15 mm for 20 watt, 39 watt and 70 watt lamps, 19 mm for 39 watt, 70 watt and 150 watt lamps, 22.5 mm for 250 watt lamps, and 30 mm for a 310 watt lamp.

The magnetic force between the arc and the supporting wire increases with the square of the current and inversely with the distance between the wire and the arc. For a given distance between the arc and a single lead wire, higher power lamps are subjected to a larger force, and the arc displacement is larger. However, for lower power the current is lower but the distance is also smaller which increases the magnetic force on the arc. Thus, the invention benefits both low wattage and high wattage lamps.

Such lamps with the looped frame assembly of this invention exhibit improved lumen maintenance and extended life over designs having an uneven current distribution. The invention has necessarily been described in terms of a limited number of embodiments. From this description, other embodiments and variations of embodiments will become apparent to those skilled in the art, and are intended to be fully encompassed within the scope of the invention and the appended claims.

1. An arc tube mounting assembly 1 for a metal halide lamp comprising;
an arc tube (2, 31) having a sidewall (2A, 31A), a top end (2B, 31B) and a base end (2C, 31C) enclosing a discharge space (3, 32) containing a fill capable of sustaining an arc discharge;
pair of end plugs (4, 35 and 5, 36) extending from opposing base and top ends (2A, 31A and 2B, 31B) of the arc tube (2, 31);
pair of discharge electrodes (6, 33 and 7, 34) arranged at opposing ends of the discharge space (3, 32), and extending out of the arc tube (2, 31) through the end plugs (4, 35 and 5, 36), respectively, in a gas-tight manner;
looped frame member 8 comprising a loop 8A and a centering circle 8B;
the loop 8A extending along one side of the arc tube (2, 31) from below the base end (2B, 31B) of arc tube (2, 31) then across the electrode (7, 34) distal from the base end (2B, 31B), making electrical contact with the distal electrode (7, 34) at a point 8D, then along an opposing side of the arc tube (2, 31), and finally crossing the end plug (6, 35) proximal to the base end (2B, 31B) and extending to a terminal end 8E, which terminal end 8E makes electrical connection with the looped frame member 8 at a point 8F above the base end 8C of the looped frame member 8;
the centering circle 8B looping around the proximal end plug (4, 35); and
a lower frame member 9 electrically connected to the proximal discharge electrode (6, 33) at a point 9A.

2. The arc tube mounting assembly 1 of claim 1, in which the arc tube 2 is tubular in shape.

3. The arc tube mounting assembly of claim 2, in which the arc tube 2 is polycrystalline alumina.

4. The arc tube mounting assembly 1 of claim 1, in which the arc tube 2 is ovoid in shape.

5. The arc tube mounting assembly of claim 2, in which the arc tube 2 is polycrystalline alumina.

6. The arc tube mounting assembly 1 of claim 1, in which the base end 8C of the looped frame member 8 is connected to a lead-through 17 via a metal foil 16, and the lower frame member 9 is connected to a lead-through 19 via a metal foil 18.

7. The arc tube mounting assembly 1 of claim 6, in which the frame members 8 and 9 are of molybdenum.

8. The arc tube mounting assembly 1 of claim 6, in which the metal foils 16 and 18 are of molybdenum.

9. A metal halide lamp 10 comprising:
an outer envelope 11 having a top end 11A and a base end 11B;
a lamp base 15; and
and an arc tube mounting assembly 1 comprising the arc tube mounting assembly of claim 1.

10. The metal halide lamp 10 of claim 9, in which the outer envelope 11 is tubular.

11. The metal halide lamp 10 of claim 10, in which the loop 8A exhibits resiliency, and the loop 8A has a width W slightly wider than the inner diameter D of the outer tubular envelope 11, so that upon insertion of the mounting assembly 1 into the envelope 11, the loop 8A bears against the inner wall 11A of envelope 11, thereby providing further alignment and support of the arc tube 1 within the envelope 11.

12. The tubular metal halide lamp 10 of claim 9, in which the centering circle 8B acts as an auxiliary electrode to aid in lamp starting.

13. The tubular metal halide lamp 10 of claim 9, in which the outer envelope 11 is of fused quartz.

14. The tubular metal halide lamp 10 of claim 7, in which the lamp is a compact tubular “T” metal halide lamps of medium wattage (>20 W to 400 W) with a color temperature target of 3000 K to 5600 K.
